(19) United States
(12) Patent Application Publication
(10) Pub. No.: US 2009/0131568 A1
(43) Pub. Date: May 21, 2009

(54) HALOGEN-FREE, FLAME-RETARDANT WIRE-AND-CABLE COMPOSITION AND RELATED ARTICLES

(75) Inventors: Maarten Aarts, Hutten (CH); Gerrit Groot-Enzerink, Gross (CH); Thomas S. Lin, Whippany, NJ (US); Jeffrey M. Cogen, Flemington, NJ (US)

Correspondence Address: The Dow Chemical Company, Intellectual Property Section, P.O. Box 1967, Midland, MI, 48641-1967, US

(73) Assignee: Dow Global Technologies Inc., Midland, MI (US)

(21) Appl. No.: 12/299,084

(22) PCT Filed: May 2, 2007
(86) PCT No.: PCT/US2007/010545

§ 371 Date: Oct. 30, 2008

Related U.S. Application Data
(60) Provisional application No. 60/797,181, filed on May 3, 2006.
(60) Provisional application No. 60/847,639, filed on Sep. 27, 2006.

(51) Int. Cl. C09K 21/14

(52) U.S. Cl. 524/322; 524/570; 524/399; 525/55; 525/192; 524/445

(57) ABSTRACT

This invention relates to a flame-retardant composition useful for preparing a coated automotive wire with high scrape abrasion resistance and flexibility. The present invention is a halogen-free, flame-retardant composition made from or containing an ethylene/alpha-olefin copolymer, a halogen-free inorganic flame retardant, a coupling agent for coupling the inorganic flame retardant to the copolymer, and a processing aid.

This invention relates to a halogen-free, flame-retardant wire-and-cable composition. In particular, this invention relates to a flame-retardant composition useful for preparing a coated automotive wire with high scrape abrasion resistance and flexibility.

### DESCRIPTION OF THE PRIOR ART

Automotive wires must pass stringent requirements, including flame retardance and scrape abrasion resistance. Standards such as ISO 6722, LV112, and J-1128 set forth requirements for flame retardance and scrape abrasion resistance.

Compositions containing halogenated polymers or halogenated flame retardants have found usefulness in flame-retardancy applications. But, these materials pose health risks and other concerns. There is a need for a halogen-free composition for preparing a flame-retardant coating for automotive wire applications.

Compositions containing high density polyethylene and copolymers of ethylene and unsaturated esters have found utility in coating automotive wire. Unfortunately, the use of high density polyethylene raises processing issues when preparing the composition or the coating. Also, copolymers of ethylene and unsaturated esters may not yield coatings with suitable scrape abrasion resistance. There is a need for a composition that provides excellent processing characteristics and yields a coating with excellent scrape abrasion resistance. There is also a need for the composition to yield a coating with high elongation at break, mechanical strength, and melt strength.

### SUMMARY OF THE INVENTION

The present invention is a halogen-free, flame-retardant composition comprising an ethylene/alpha-olefin copolymer, a halogen-free inorganic flame retardant, a coupling agent for coupling the inorganic flame retardant to the copolymer, and a processing aid.

In a preferred embodiment, the present invention is a coated automotive wire wherein the coating is prepared from the halogen-free, flame-retardant composition.

### DESCRIPTION OF THE INVENTION

“Polymer,” as used herein, means a macromolecular compound prepared by polymerizing monomers of the same or different type. “Polymer” includes homopolymers, copolymers, terpolymers, interpolymers, and so on. The term “interpolymer” means a polymer prepared by the polymerization of at least two types of monomers or comonomers. It includes, but is not limited to, copolymers (which usually refers to polymers prepared from two different types of monomers or comonomers, although it is often used interchangeably with “interpolymer” to refer to polymers made from three or more different types of monomers or comonomers), terpolymers (which usually refers to polymers prepared from three different types of monomers or comonomers), tetrapolymers (which usually refers to polymers prepared from four different types of monomers or comonomers), and the like.

The terms “monomer” or “comonomer” are used interchangeably, and they refer to any compound with a polymerizable moiety which is added to a reactor in order to produce a polymer. In those instances in which a polymer is described as comprising one or more monomers, e.g., a polymer comprising propylene and ethylene, the polymer, of course, comprises units derived from the monomers, e.g., —CH₂—CH₂—, and not the monomer itself, e.g., CH₂═CH₂.

In a first embodiment, the present invention is a halogen-free, flame-retardant composition comprising an ethylene/alpha-olefin copolymer, a halogen-free inorganic flame retardant, a coupling agent for coupling the inorganic flame retardant to the copolymer, and a processing aid. The composition is substantially free of copolymers of ethylene and unsaturated esters and substantially free of halogenated components. Preferably, the composition is absent any copolymers of ethylene and unsaturated esters and absent halogenated components.

The ethylene/alpha-olefin copolymers useful in the present invention are copolymers of ethylene and one or more alpha-olefins having 3 to 12 carbon atoms, and preferably 4 to 8 carbon atoms, or a mixture or blend of such copolymers. The alpha-olefin comonomer can be present in amount between about 2 percent and about 12 percent. When the copolymer is a mixture or blend of copolymers, it can be a mechanical blend or an in situ blend. Examples of the alpha-olefins are propylene, 1-butene, 1-hexene, 4-methyl-1-pentene, and 1-octene.

The copolymers usually have a polydispersity (Mw/Mn) greater than about 5.0 Mw is defined as weight average molecular weight, and Mn is defined as number average molecular weight.

The copolymers can have a density in the range of about 0.860 to about 0.960 grams per cubic centimeter, and preferably have a density in the range of about 0.915 to about 0.945 grams per cubic centimeter.

They also can have a melt index in the range of about 0.5 to about 5.0 grams per 10 minutes. Melt index is determined under ASTM D-1238, Condition E and measured at 190 degree Celsius and 2160 grams.

Catalyst systems useful for preparing copolymers include, but are not limited to, metallocene or constrained geometry catalyst systems.

The ethylene/alpha-olefin copolymer is preferably present in an amount between about 20 weight percent and about 80 weight percent.

Suitable halogen-free inorganic flame retardants include metal hydroxides, calcium carbonate, and mixtures thereof. Particularly useful metal hydroxides are aluminum trihydroxide (also known as ATH or aluminum trihydrate) and magnesium hydroxide (also known as magnesium dihydroxide). Other metal hydroxides are known to persons of ordinary skill in the art. Preferably, the metal hydroxide is a magnesium hydroxide.

The average particle size of the metal hydroxide may range from less than 0.1 micrometers to 50 micrometers. In some cases, it may be desirable to use a metal hydroxide having a nanoscale particle size. The metal hydroxide may be naturally occurring or synthetic, ground or precipitated.

Also, it is desirable, when the halogen-free inorganic flame retardant is a metal hydroxide, that the metal hydroxide be finely dispersed or have a specific surface area in the range of about 5 square meters to about 15 square meters per gram, preferably in the range of about 9 square meters to about 11 square meters per gram.

To enhance coupling of the halogen-free inorganic flame retardant to the ethylene/alpha-olefin copolymer, the flame retardant can be surface treated with a coupling agent, including silanes, titanates, zirconates, carboxylic acids, and maleic anhydride-grafted polymers. Suitable coatings include those disclosed in U.S. Pat. No. 6,500,882. Preferably, the coating is silane-based or oleic acid-based. Other suitable coupling agents would be known to persons skilled in the art. The use of those surface-treated, halogen-free inorganic flame retardant is within the scope of the present invention.

The halogen-free inorganic flame retardant is preferably present in an amount between about 20 weight percent and about 70 weight percent.

The halogen-free, flame-retardant composition may contain other flame-retardant additives. Other suitable non-halogenated flame retardant additives include red phosphorus, silica, alumina, titanium oxides, carbon nanotubes, talc, clay, organo-modified clay, silicone polymer, zinc borate, antimony trioxide, wollastonite, mica, hindered amine stabilizers, ammonium octamolybdate, melamine octamolybdate, frits, hollow glass microspheres, intumescent compounds, expandable graphite, ethylene diamine phosphate, melamine phosphate, melamine pyrophosphate, melamine polyphosphate, and ammonium polyphosphate.

The halogen-free, flame-retardant composition contains a coupling agent to improve the compatibility between the inorganic flame retardant and the copolymer. Examples of coupling agents include silanes, titanates, zirconates, various polymers grafted with maleic anhydride, maleic anhydrides grafts onto the copolymer, and mixtures thereof. Preferably, the coupling agent is a homo- or co-polymer polyethylene grafted with maleic-acid-anhydride or the ethylene/alpha-olefin copolymer with maleic anhydride grafts onto the copolymer. Other coupling technology would be readily apparent to persons of ordinary skill in the art and is considered within the scope of this invention.

The grafted olefinic polymers may be prepared by any conventional method.

The maleic anhydride compounds are known in the relevant arts as having their olefin unsaturation sites conjugated to the acid groups. Fumaric acid, an isomer of maleic acid which is also conjugated, gives off water and rearranges to form maleic anhydride when heated, and thus is operable in the present invention. Grafting may be effected in the presence of oxygen, air, hydroperoxides, or other free radical initiators, or in the essential absence of these materials when the mixture of monomer and polymer is maintained under high shear and heat conditions. A convenient method for producing the graft polymer is extrusion machinery, although Brabender mixers or Banbury mixers, roll mills and the like may also be used for forming the graft polymer. It is preferred to employ a twin-screw devolatilizing extruder (such as a Werner-Pfleiderer twin-screw extruder) wherein maleic anhydride is mixed and reacted with the olefinic polymer at molten temperatures to produce and extrude the grafted polymer.

The anhydride groups of the grafted polymer generally comprise from about 0.001 to about 2.00 weight percent, preferably from about 0.01 to about 1.00 weight percent of the grafted polymer. The grafted polymer is characterized by the presence of pendant anhydride groups along the polymer chain.

The coupling agent is preferably present in an amount between about 2 weight percent and about 15 weight percent, more preferably between about 2 weight percent and about 13 weight percent.

The halogen-free, flame-retardant composition contains a processing aid selected from the group consisting of silicon polymers, stearic acid, fluoropolymers, zinc stearate, and mixtures thereof. Preferably, the processing aid is a combination of polysiloxane and stearic acid.

The processing aid is preferably present in an amount between about 0.2 weight percent and about 5 weight percent.

In addition, the halogen-free, flame-retardant composition may contain other additives such as high density polyethylene, acid donors, antioxidants, stabilizers, blowing agents, carbon black, pigments, peroxides, and cure boosters. When a high density polyethylene is present, it is present in an amount less than about 10 weight percent. Furthermore, the halogen-free, flame-retardant composition may be thermoplastic or crosslinked.

In addition, the halogen-free, flame-retardant composition may contain a nanoclay. Preferably, the nanoclay has at least one dimension in the 0.9 to 200 nanometer-size range, more preferably at least one dimension in the 0.9 to 150 nanometers, even more preferably 0.9 to 100 nanometers, and most preferably 0.9 to 30 nanometers.

Preferably, the nanoclays are layered, including nanoclays such as montmorillonite, magadiite, fluorinated synthetic mica, saponite, fluorhectorite, laponite, sepiolite, attapulgite, hectorite, beidellite, vermiculite, kaolinite, nontronite, volkonskoite, stevensite, pyrosite, sauconite, and kenyaite. The layered nanoclays may be naturally occurring or synthetic.

Some of the cations (for example, sodium ions) of the nanoclay can be exchanged with an organic cation, by treating the nanoclay with an organic cation-containing compound. Alternatively, the cation can include or be replaced with a hydrogen ion (proton). Preferred exchange cations are imidazolium, phosphonium, ammonium, alkyl ammonium, and polyalkyl ammonium. An example of a suitable ammonium compound is dimethyl, di(hydrogenated tallow) ammonium. Preferably, the cationic coating will be present in 15 to 50% by weight, based on the total weight of layered nanoclay plus cationic coating. In the most preferred embodiment, the cationic coating will be present at greater than 30% by weight, based on the total weight of layered nanoclay plus cationic coating. Another preferred ammonium coating is octadecyl ammonium.

In an alternate embodiment, the present invention is an article prepared from the halogen-free, flame-retardant composition. Preferably, the article is an automotive wire coated with an insulation layer prepared from the composition. Other articles include cable sheaths and insulated wires for buildings and other constructions.

What is claimed is:

1. A halogen-free, flame-retardant composition comprising:
a. an ethylene/alpha-olefin copolymer prepared with a metallocene or constrained geometry catalyst, having an alpha-olefin comonomer content in the range of about 2 percent to about 12 percent, a polydispersity index greater than about 5.0, a melt index in the range of about 0.5 grams per 10 minutes to about 5.0 grams per 10 minutes, and a density in the range of about 0.860 grams per cubic centimeter to about 0.960 grams per cubic centimeter, and being substantially free of oxygen atoms,
b. a halogen-free inorganic flame retardant,
c. a coupling agent for coupling the inorganic flame retardant to the copolymer, and
d. a processing aid,
wherein the composition being substantially free of copolymers of ethylene and unsaturated esters and substantially free of halogenated components.

2. The halogen-free, flame-retardant composition according to claim 1 wherein the halogen-free inorganic flame retardant being selected from the group consisting of metal hydroxides, calcium carbonate, and mixtures thereof.

3. The halogen-free, flame-retardant composition according to claim 1 wherein the coupling agent being selected from the group consisting of silanes, titanates, zirconates, polymers grafted with maleic anhydride, maleic anhydrides grafts onto the copolymer, and mixtures thereof.

4. The halogen-free, flame-retardant composition according to claim 3 wherein the coupling agent being a polyethylene grafted with maleic-acid-anhydride.

5. The halogen-free, flame-retardant composition according to claim 1 wherein the processing aid being selected from the group consisting of silicon polymers, stearic acid, fluoropolymers, zinc stearate, and mixtures thereof.

6. The halogen-free, flame-retardant composition according to claim 5 wherein the processing aid being a polysiloxane.

7. The halogen-free, flame-retardant composition according to claim 1 further comprising high density polyethylene.

8. The halogen-free, flame-retardant composition according to claim 1 further comprising a nanoclay.

9. An automotive wire coated with an insulation layer prepared from a halogen-free, flame-retardant composition according to any of claims 1-8.
